(19) United States
(12) Patent Application Publication
(10) Pub. No.: US 2024/0417487 A1
(43) Pub. Date: Dec. 19, 2024

(54) JANUS-TYPE SPHERICAL CELLULOSE NANOPARTICLES

(71) Applicant: AUT VENTURES LIMITED, Auckland (NZ)

(72) Inventors: Jack Li-Yang Chen, Auckland (NZ); Bryan Andres Tiban Anrango, Auckland (NZ)

(21) Appl. No.: 18/708,295

(22) PCT Filed: Nov. 7, 2022
(86) PCT No.: PCT/IB2022/060708

§ 371 Date: May 8, 2024

(30) Foreign Application Priority Data
Nov. 9, 2021 (AU) 2021903573

(51) Int. Cl. C08B 3/10; B01J 13/00; C08B 1/02; C08B 11/02; C09K 23/48

(52) U.S. Cl. CPC C08B 3/10; B01J 13/0021; B01J 13/0039; C08B 1/02; C08B 11/02; C09K 23/48

(57) ABSTRACT

The invention relates to Janus-type spherical cellulose nanoparticles and processes for producing them. The Janus-type spherical cellulose nanoparticles of the invention are chemically modified on one face only, producing particles with a lipophilic face opposite a hydrophilic face. Such particles demonstrate superior surfactant properties and can be used to prepare Pickering emulsions.

### 1. FIELD OF THE INVENTION

The present invention relates to Janus-type spherical cellulose nanoparticles, processes for preparing said nanoparticles and Pickering emulsions comprising said nanoparticles.

### 2. BACKGROUND TO THE INVENTION

Surfactants are chemical additives used in products such as paints, pesticides, cleaning products and cosmetics. Conventional surfactants are molecules with one water-soluble end and one oil-soluble end. This amphiphilic structure allows incompatible liquids, such as oil (or oil-soluble compounds) to mix homogeneously with water. Surfactants allow this mixing by sitting at the interface between oil and water, stabilising the microscopic bubbles of oil (the dispersed phase) within the water (the continuous phase) and creating a homogeneous mixture known as an emulsion. In this context, these surfactants act as emulsifiers.

The properties of a synthetic surfactant can be modified by the length (and number of chains) of the lipophilic portion and the size and charge of the hydrophilic portion. A key measure of the physical characteristics of a surfactant is its hydrophilic-lipophilic balance (HLB), a number that is used to determine the application to which it is best suited. Depending on their HLB, surfactants can be used as detergents, emulsifiers, wetting agents, foaming agents, dispersants and defoamers.

For example, in general surfactants with HLB values of 13-15 are used as detergents; surfactants with HLB values of 8-16 are used as oil-in-water emulsifiers; surfactants with HLB values of 3-6 are used as water-in-oil emulsifiers; and surfactants with HLB values of 2-3 are used as antifoaming agents.

The surfactants in use today cannot be recovered and are discharged into waterways; an issue facing increasing scrutiny from regulatory organisations. They are thus considered environmental pollutants. Some surfactants have also been found to be endocrine disruptors, such as the alkylphenols—a class of surfactants restricted in the European Union due to its effects on human health and the environment (Regulation No 648/2004). In addition, the majority of surfactants in use today are partially or wholly derived from an unsustainable petrochemical industry. The tightening of environmental regulation and strong public demand for green and sustainable technologies has created a need for new surfactants that are sustainably sourced and fully biodegradable.

Emulsions formed from oil and water can also be stabilised by the addition of particles rather than molecule-based surfactants. Small molecules tend to rapidly adsorb and desorb from the oil-water interface and therefore do not always provide high emulsion stability over time. Particles are known to possess a much higher affinity for the water/oil interface than molecules due to their larger size and stabilise emulsions more efficiently due to their ability to keep the two immiscible layers apart. Thus, they act as more efficient emulsifiers. Emulsions formed using a particulate surfactant are known as Pickering emulsions.

A Pickering emulsion comprises a shell of particles located at the interfaces between the dispersed phase droplets and the continuous phase. Pickering emulsions are typically made by combining an oil, water and solid particles (typically less than 100 μm in diameter) and then vigorously mixing, for example in a blender. Depending on the relative amounts of the water and oil, the size and nature of the solid particles (generally the phase that preferentially wets the particle will be the continuous phase), a water-in-oil or oil-in-water Pickering emulsion is formed, where the presence of the solid particles stablises the emulsion by preventing the dispersed phase droplets from coalescing.

Well-known particulate surfactants (also called Pickering particles) include hydroxyapatite nanoparticles, silica and clay materials, iron oxide nanoparticles, carbon nanotubes and chitosan nanoparticles. However, cellulose particles are increasingly finding application as particulate surfactants.

Cellulose (a carbohydrate polymer) is the most abundant renewable polymer in nature, representing about 50% of the Earth's natural biomass. Cellulose ((C₆H₁₀O₅) n where n=10000 to 15000) is a tough, fibrous, water-insoluble substance defined as a long polymer chain of 1,4 anhydro-D-glucopyranose units, with a flat, ribbon-like conformation.

Native cellulose is fibrillar and crystalline. Cellulose does not exist as a single polymer molecule, but multiple cellulose polymers (30 to 100) packed together via van der Waals forces and hydrogen bonds form the basic units of cellulose fibres—the elementary fibril, which exists at the nano-scale in diameter and micro-scale in length. These elementary fibrils are further gathered by intermolecular and intramolecular hydrogen bonding into microfibrils that display cross dimensions ranging from 2 to 20 nm. Their aspect ratios can vary from around 40 (e.g. ˜200 nm long and 5 nm wide for cotton) to around 66 (e.g. ˜1 μm long and 15 nm wide for tunicin).

Common sources of cellulose include cotton, hemp, flax, hardwood and bacterial cellulose. Acid hydrolysis and enzymatic digestion can be used to extract the crystalline regions from the cellulose microfibres. The crystalline rods formed are known as cellulose nanocrystals which have lengths of about 160-200 nm and cross sections of about 7-25 nm.

While showing promise in a vast range of applications, cellulose nanocrystals are of great potential as particulate surfactants because of their high mechanical strength and surface area. They are also biodegradable and biocompatible and so may be preferred to petrochemical-derived molecular surfactants.

The monomeric glucose units within the cellulose chain possess several hydroxyl groups, which provide reactive platforms for chemical modifications. Accordingly, the physical properties of cellulose nanocrystals can be readily modified.

Cellulose has an inherently hydrophilic nature due to the presence of hydroxyl (—OH) groups on its surface, which can form hydrogen bonds with water. However, the surface functionality of cellulose nanocrystals can be changed using a number of methods, including but not limited to, TEMPO-mediated oxidation, periodate oxidation (increasing hydrophilicity) and esterification and long alkyl chain grafting (decreasing hydrophilicity). Many modified cellulose nanocrystals have been shown to be good at stabilising Pickering emulsions, including spherical cellulose nanoparticles (Dong, Ding, Jiang, Li, & Han, 2021).

Another way of improving the surfactant properties of a particle is to introduce heterogeneity into the faces of the particle. Janus particles are particles whose surfaces have two distinct physical properties; for example, a lipophilic face opposite a hydrophilic face. Janus particles of this type make excellent emulsifiers because they combine the amphiphilic properties of molecular surfactants with the higher interface affinity of a particulate surfactant.

C. Casagrande and M. Veyssié in 1989 reported the first Janus “beads” that offered amphiphilicity within a single solid particle of diameter in the range of 50-90 μm (Casagrande, Fabre, Raphaël, & Veyssié, 1989). These Janus “beads” were prepared from glass spheres with one side having a cellulose (hydrophilic) varnish and the other side treated with octadecyltrichlorosilane (lipophilic). It was found that when dispersed at oil-water interfaces, these Janus “beads” were always symmetrically positioned at the interface with the lipophilic half immersed in the oil side and the hydrophilic half in the water.

Janus particles can be produced by masking one side of the particle (which can be achieved by evaporation deposition or suspending the particles at the interface of two phases) and then chemically altering the unmasked side. However, methods for producing Janus particles at the nanometre scale are severely limited, due to the ability of particles to rotate in solution, causing poor control of modification on a single face. Therefore, despite the growing interest in cellulose nanocrystals, Janus-type cellulose nanocrystals are rare.

In 2020, Li et al described making Janus-type cellulose nanocrystals in the manufacture of palladium/cellulose nanoparticle interfacial Pickering catalysts (Li, Jiang, & Cai, 2020). Li et al formed a Pickering emulsion from cellulose nanocrystals in a wax/water solution at 75° C. in the presence of cetyltrimethylammonium bromide (CTAB). Once the cellulose nanocrystals had located to the emulsion interface, the solution was rapidly cooled, leaving the nanocrystals locked on the surface of the now solid wax droplets. A lipophilic modifier (1-bromohexadecane) was reacted with the exposed faces of the cellulose nanocrystals.

The cellulose nanocrystals used were rod-like particles with dimensions of about 0.5-3 μm in length and 50-150 nm in diameter. After modification, the cetyl-modified cellulose nanocrystals had average lengths of about 0.5-5 μm.

The modified cellulose nanocrystals described above are fairly large and have a high aspect ratio, which is not optimal in a particulate surfactant. Particles stabilise Pickering emulsions by adsorbing at the high-energy oil-water interface, which decreases the area of the surface at which the oil and water phases come directly in contact with each other. Smaller particles are more efficient in this role, as they can be more efficiently packed leaving smaller gaps between particles where the water and oil phases would otherwise be in contact. Spherical particles also allow for more efficient packing than elongated rods or fibres, which tend to form bundles and tangle rather than packing uniformly at the interface.

Unfortunately, researchers have not yet found a way to combine the superior surfactant properties resulting from facial distinction, with the superior interfacial stabilisation of spherical cellulose nanoparticles. Therefore, presently available cellulose-based surfactants are not as effective as less environmentally detrimental products.

Accordingly, it is an object of the invention to provide Janus-type spherical cellulose nanoparticles that go at least some way in alleviating some of the deficiencies of the prior art surfactants and/or at least to provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### 3. SUMMARY OF THE INVENTION

The invention relates generally to a process for increasing the lipophilicity of one face of a spherical cellulose nanoparticle to improve its surfactant properties.

In one aspect the invention provides a process for preparing Janus-type spherical cellulose nanoparticles comprising:
(a) preparing an alkali suspension of spherical cellulose nanoparticles in water;
(b) forming an emulsion comprising the spherical cellulose nanoparticles, water and a water-immiscible lipophilic solvent, wherein:
   (i) the water constitutes the continuous phase,
   (ii) the lipophilic solvent constitutes the dispersed phase and comprises a lipophilicity modifier, and
   (iii) the spherical cellulose nanoparticles are localised at the interface of the continuous and dispersed phases;
(c) reacting the lipophilicity modifier with the portion of the spherical cellulose nanoparticles exposed to the lipophilicity modifier at the interface of the continuous and dispersed phases to produce Janus-type spherical cellulose nanoparticles;
(d) separating the Janus-type spherical cellulose nanoparticles from the emulsion.

In another aspect, the invention provides Janus-type spherical cellulose nanoparticles. In one embodiment, the Janus-type spherical cellulose nanoparticles are prepared in accordance with the process of the invention.

### 4. BRIEF DESCRIPTION OF THE FIGURES

The invention will now be described by way of example only and with reference to the drawings in which:

FIG. 1 is a diagram showing the process for modification of spherical cellulose nanoparticles with a lipophilicity modifier to generate Janus-like spherical cellulose nanoparticles

FIG. 2 is a pair of micrographs of the spherical cellulose nanoparticles prepared in accordance with Example 1.

FIG. 3 is a pair of micrographs of the Janus cellulose nanoparticles prepared in accordance with Example 2. A) following modification with 1-bromohexadecane for 2 h. b) following modification with 1-bromohexadecane for 12 h.

FIG. 4 is a pair of photographs of a 1:1 vol % toluene-in-water emulsion stabilised by Janus-type spherical cellulose nanoparticles at day 0 and 60, as described in Example 3.

FIG. 5 is a set of photographs of 1:1 vol % toluene-in-water emulsions stabilised by either sodium dodecylbenzene sulfonate or polyoxyethylene (10) oleyl ether. A) sodium dodecylbenzene sulfonate at day 0. b) sodium dodecylbenzene sulfonate at day 60. c) polyoxyethylene (10) oleyl ether at day 0. d) polyoxyethylene (10) oleyl ether at day 60, as described in Example 3.

FIG. 6 is a pair of photographs of 1:9 v % toluene-in-water emulsion stabilised by Janus-type spherical cellulose nanoparticles at a) day 0. b) day 30, as described in Example 4.

FIG. 7 is a set of photographs of 1:9% v toluene in water emulsions stabilised by a) polyoxyethylene (10) oleyl ether at day 0. b) polyoxyethylene (10) oleyl ether at day 30. c) sodium dodecylbenzene sulfonate at day 0. d) sodium dodecylbenzene sulfonate at day 30, as described in Example 4.

FIG. 8 is a graph showing the surface tension reduction of water by Janus-type spherical nanoparticles of the invention prepared using chloroform as the water immiscible lipophilic solvent without stirring at different reaction times, as described in Example 5.

FIG. 9 is a graph showing the surface tension reduction of water by Janus-type spherical nanoparticles of the invention prepared using chloroform as the water immiscible lipophilic solvent with stirring at different reaction times, as described in Example 5.

FIG. 10 is a graph showing the surface tension reduction of water by Janus-type spherical nanoparticles of the invention prepared using toluene as the water immiscible lipophilic solvent without stirring at different reaction times, as described in Example 5.

FIG. 11 is a graph showing the surface tension reduction of water by Janus-type spherical nanoparticles of the invention prepared using chloroform as the water immiscible lipophilic solvent with stirring at different reaction times, as described in Example 5.

FIG. 12 is an SEM micrograph of an emulsion droplet stabilised by Janus-type spherical nanoparticles prepared in accordance with Example 2.

FIG. 13 is a micrograph of an emulsion stabilised by Janus-type spherical nanoparticles prepared in accordance with Example 2 (Scale bar: 100 μm).

FIG. 14 is a photograph comparing the emulsification ability of a) commercially available cellulose microparticles, b) cellulose nanocrystals, c) spherical cellulose particles, and d) Janus-type spherical cellulose nanoparticles of the invention.

FIG. 15 is a pair of photographs showing the 1:9 toluene-in-water Pickering emulsions of Example 6 after 5 min (FIG. 15A) and 7 days (FIG. 15B). From left to right: Janus-type spherical particles modified with 1-bromohexadecane for 2 h, 6 h, 12 h, 24 h, spherical cellulose particles, and Brij O10.

FIG. 16 is a pair of photographs showing the 1:1 toluene-in-water Pickering emulsions of Example 6 after 5 min (FIG. 15A) and 7 days (FIG. 15B). From left to right: Janus-type spherical particles modified with 1-bromohexadecane for 2 h, 6 h, 12 h, 24 h, spherical cellulose particles, and Brij O10.

FIG. 17 is a graph showing the creaming index over time for the 1:9 v 12 hr and Brij O10 Pickering emulsions of Example 6 (FIG. 17A) and photographs at 0 (top) and 14 (bottom) days (FIG. 17B).

FIG. 18 is a graph showing the creaming index over time for the 1:1 v 12 hr and Brij O10 Pickering emulsions of Example 6 (FIG. 18A) and photographs at 0 (top) and 14 (bottom) days (FIG. 18B).

FIG. 19 is a pair of graphs showing the UV absorbance at 550 nm of the Pickering emulsions produced in Example 6. FIG. 19A shows the 1:9 v emulsions and FIG. 19B shows the 1:1 v emulsions.

FIG. 20 is a photograph of a set of solutions showing the amount of foam produced when a surfactant-containing solution is introduced from a reservoir from a specific height into a column containing the same solution, in accordance with the Ross-Miles method (ASTM D1173). A=unmodified spherical cellulose nanoparticles, B=Janus-type spherical cellulose particles modified with 1-bromohexadecane for 12 hours, C=C12-C15 pareth-7, D=lauryl glucoside, E=sodium lauryl sulfate. Each emulsion comprises 0.1 wt % surfactant in 250 mL deionised water at 21° C., measurement taken after 1 min.

FIG. 21 is a graph showing the surface tension reduction of water in the presence of spherical cellulose nanoparticles that have been homogeneously modified with the lipophilic modifier bromohexadecane for set times (1, 4, 6 and 12 hours).

### 5. DETAILED DESCRIPTION OF THE INVENTION

### 5.1 Definitions and Abbreviations

As used herein the term “comprising” means “consisting at least in part of”. When interpreting each statement in this specification that includes the term “comprising”, features other than that or those prefaced by the term may also be present. Related terms such as “comprise” and “comprises” are to be interpreted in the same manner.

The term “about” as used herein means a reasonable amount of deviation of the modified term such that the end result is not significantly changed. For example, when applied to a value, the term should be construed as including a deviation of +/−10% of the value.

The term “emulsion” as used herein refers to a combination of at least two liquids, where one of the liquids is present in the form of droplets in the other liquid. IUPAC, Compendium of Chemical Terminology: IUPAC Recommendations, 2^{nd} ed., compiled by A. D. McNaught and A. Wilkinson, Blackwell, Oxford (1997).

The term “surfactant” as used herein refers to a molecule or particle comprising two parts of different polarity, one generally being lipophilic (soluble or dispersible in an oily phase) and one being hydrophilic (soluble or dispersible in water). Surfactants are characterised by their HLB (hydrophilic-lipophilic balance) value. The term “HLB” is well known in the art and is described, for example, in “The HLB system. A time-saving guide to Emulsifier Selection” (published by ICI Americas Inc., 1984). The term “wettability” is commonly used to describe the hydrophilicity/lipophilicity of particles used to stabilise Pickering emulsions. To maintain consistency, the term “HLB” is used herein to describe the surfactant properties of both molecules and particles.

The term “volume particle diameter” as used herein, means the diameter of a sphere that has the same volume as the particle being measured. The “volume average particle diameter” of a particulate substance is the average value of the volume particle diameter of the particles being measured.

The term “sphericity” as used herein, is a measure of the degree to which a particle approximates the shape of a sphere. The sphericity of a particle is the ratio of the surface area of a sphere with the same volume as the given particle to the surface area of the particle. A perfect sphere has a sphericity of 1. The sphericity of a particle can be assessed by viewing the projected area of a particle appearing in an electron micrographic image and comparing the ratio of the circumferential length of a circle having the same area as the projected area and actual circumferential length of the particle appearing in the electron micrographic image. In this method, each particle is observed only at a plane, but the variation in the observation direction can be accounted for by using an average value for many particles.

The term “spherical” as used herein, refers to a particle of sphericity from 0.5 to 1.0.

The term “lipophilicity” as used herein, refers to the ability of a substance to dissolve in other lipophilic substances such as fats, oils and non-polar compounds such as hexane.

The term “cellulose nanocrystals” as used herein, refers to the crystalline regions of cellulose microfibres, that have lengths of about 160-200 nm and cross-sections of about 7-25 nm.

The term “cellulose nanoparticle” as used herein, refers to a nanoparticle produced from a source of cellulose, for example microcellulose. Cellulose nanoparticles may be surface modified with other agents but comprise at least a cellulose core.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

### 5.1 the Janus-Type Spherical Cellulose Nanoparticles of the Invention

The invention relates generally to a process for increasing the lipophilicity of one face of a spherical cellulose nanoparticle to improve its surfactant properties.

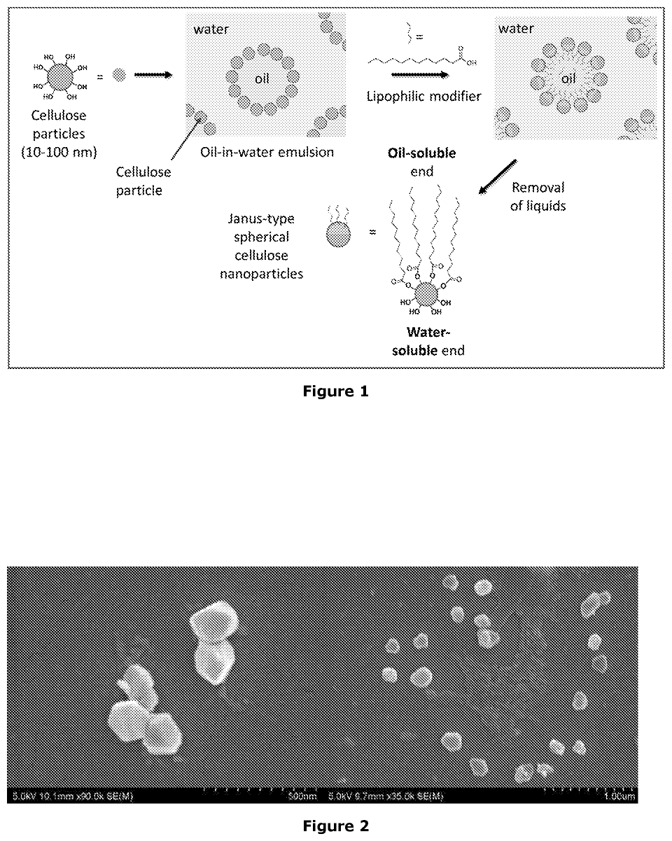

The process uses the affinity of cellulose nanoparticles for an oil/water interface and results in novel Janus-type spherical cellulose nanoparticles. A diagram setting out one embodiment of the process is shown in FIG. 1.

In one aspect the invention provides a process for preparing Janus-type spherical cellulose nanoparticles comprising:
(a) preparing an alkali suspension of spherical cellulose nanoparticles in water;
(b) forming an emulsion comprising the spherical cellulose nanoparticles, water and a water-immiscible lipophilic solvent, wherein:
   (i) the water constitutes the continuous phase,
   (ii) the lipophilic solvent constitutes the dispersed phase and comprises a lipophilicity modifier, and
   (iii) the spherical cellulose nanoparticles are localised at the interface of the continuous and dispersed phases;
(c) reacting the lipophilicity modifier with the portion of the spherical cellulose nanoparticles exposed to the lipophilicity modifier at the interface of the continuous and dispersed phases to produce Janus-type spherical cellulose nanoparticles;
(d) separating the Janus-type spherical cellulose nanoparticles from the emulsion.

The process of the invention modifies spherical cellulose nanoparticles, to improve their surfactant properties. Conventional cellulose nanoparticles are nanocrystals that have high aspect ratios and are formed as rods or fibrils. Cellulose nanocrystals are generally prepared from microcellulose (microcrystalline cellulose).

Spherical cellulose nanoparticles (or nanospheres) possess larger surface areas, which improves their surface activity, but they are difficult to produce. This is because of the high crystallinity of microcellulose fibrils, which make them difficult to break down to nanoscale spherical cellulose. However, a number of preparation processes have been published. Examples include U.S. Pat. No. 8,629,187 and references therein.

Microcellulose is a commercially available free-flowing powder comprising refined wood pulp. Generally, microcellulose particles have a volume average particle diameter of about 18-22 μm.

Methods for converting microcellulose to spherical cellulose particles often use strong bases such as NaOH or strong acids such as HCl and H₂SO₄, sometimes in combination with ultrasound sonication to break up the fibrils and decrease the crystallinity. For example, see (Meyabadi, Dadashian, Sadeghi, & Asl, 2014) (Li, et al., 2020). Alternative methods include enzymatic degradation using, for example, cellulases and xylanases to break down the polymers (Chen, Deng, Shen, & Jia, 2018).

The process of the invention may use spherical cellulose nanoparticles prepared by any known process. As set out in Example 1, the inventors prepared spherical cellulose nanoparticles for modification using a variation of the method described in (Zhang, Elder, Pu, & Ragauskas, 2007). FIG. 2 provides micrographs of the prepared nanoparticles.

In one embodiment the spherical cellulose nanoparticles are prepared from microcelllulose derived from Kraft pulp. This followed a similar procedure as described in Example 1, but with optimisation of the time for NaOH hydrolysis and acid hydrolysis.

In one embodiment the spherical cellulose nanoparticles have a volume average particle diameter of about 10 nm to about 1000 nm, preferably about 20 nm to about 600 nm, more preferably about 20 to about 200 nm.

In one embodiment, the spherical cellulose nanoparticles have an average sphericity of greater than about 50, 60, 70, 80, 90, 95% or 98%, preferably greater than about 75%, more preferably greater than about 90% or higher.

In step (a) of the process of the invention, an alkali suspension of spherical cellulose nanoparticles in water is formed.

In one embodiment, the alkali suspension of spherical cellulose nanoparticles is prepared by adding strong base to spherical cellulose nanoparticles suspended in water. In one embodiment the water is deionised, distilled or milli-Q water.

In one embodiment the alkali suspension comprises about 0.01 to about 10 wt % spherical cellulose nanoparticles.

In one embodiment the strong base is selected from the group consisting of NaOH, KOH and LiOH, preferably NaOH. In one embodiment the strong base has a concentration of at least about 2M, preferably about 2-5M.

In one embodiment the strong base is added to the suspension of spherical cellulose nanoparticles in a wt ratio of about 1:1 to about 2:1 strong base: spherical cellulose nanoparticles.

In one embodiment, a salt is added to the alkali suspension to increase its ionic strength. Any salt that does not interfere with the reaction in step (c) may be used. Generally, the amount of salt added would result in a solution of 0 to 100 mM salt.

In one embodiment, the salt is selected from the group consisting of NaCl, KCl, MgCl₂, NaNO₃ and the like. In one embodiment, the salt is NaCl.

In one embodiment, the salt is added to the alkali suspension about 5 to about 60 min after the strong base has been added, preferably about 10-15 min after.

In one embodiment, the alkali suspension is mixed until the particles are homogenously dispersed. In one embodiment, the alkali suspension of spherical cellulose nanoparticles is homogenised by sonification.

In step (b) the alkali suspension is mixed with a water-immiscible lipophilic solvent to form an emulsion, in which the water constitutes the continuous phase and the lipophilic solvent constitutes the dispersed phase.

The water-immiscible lipophilic solvent may be any solvent or mixture of solvents that has high enough lipophilicity to be immiscible with water, including but not limited to, toluene, chloroform, hexane, pentane, benzene, carbon tetrachloride, heptane dichloromethane, ethyl acetate and the like. In one embodiment, the water-immiscible solvent comprises toluene.

In one embodiment the resulting emulsion comprises about 0.1 to 10% vol water-immiscible lipophilic solvent to water.

The water-immiscible lipophilic solvent comprises a lipophilicity modifier. A lipophilicity modifier is a reagent suitable for modifying the lipophilicity of the exposed surface of the spherical cellulose nanoparticles, ie, the portion of the surface that is in contact with the dispersed phase. The lipophilicity modifier reacts with the hydroxyl groups present on the surface of the spherical cellulose nanoparticles, converting them to a more lipophilic group, such as an ester or ether group.

In one embodiment the lipophilicity modifier comprises an organic compound that includes at least one (C₁-C₂₀) alkyl group and a leaving group.

In one embodiment the lipophilicity modifier comprises an ester that is formed from at least one (C₁-C₂₀) carboxylic acid and an alcohol (e.g. glycerol).

In one embodiment the lipophilicity modifier reacts with hydroxyl groups on the surface of the spherical cellulose nanoparticles to produce (C₁-C₂₀) ether groups. In one embodiment the lipophilicity modifier reacts with hydroxyl groups on the surface of the spherical cellulose nanoparticles to produce (C₁-C₂₀) ester groups.

The lipophilicity modifier may be added to the water-immiscible lipophilic solvent prior to emulsification, or it may also constitute the water-immiscible lipophilic solvent itself, where it is economical and/or practical to do so.

Accordingly, in one embodiment, the water-immiscible lipophilic solvent is also the lipophilicity modifier.

For example, in one embodiment the water-immiscible lipophilic solvent and lipophilicity modifier is a fatty acid-containing lipid such as a triacylglyceride or similar reagent containing ester functional groups. The triacylglyceride reacts with hydroxyl groups on the surface of the spherical cellulose nanoparticles to produce ester groups. This is described as a transesterification reaction.

In one embodiment, the water-immiscible lipophilic solvent is a plant oil. Plant oils contain high concentrations of triacylglycerides. Where a plant oil is used as the lipophilic solvent, the triacylglycerides comprise the lipophilicity modifier.

In one embodiment the plant oil is selected from the group consisting of coconut oil, hemp oil, rapeseed oil, sunflower oil and palm oil.

In one embodiment the lipophilicity modifier is added to the water-immiscible lipophilic solvent prior to emulsification. The lipophilicity modifier is more commonly added to a separate water-immiscible lipophilic solvent where it is too expensive or otherwise impractical to also use the lipophilicity modifier as a solvent.

In one embodiment the lipophilicity modifier comprises an alkyl halide or pseudohalide, including but not limited to alkyl bromide, alkyl chloride, alkyl iodide, alkyl mesylate, alkyl tosylate.

In one embodiment the lipophilicity modifier comprises (C₁-C₂₀)-bromoalkane, preferably (C₁₂-C₁₆)-bromoalkane. In one embodiment the lipophilicity modifier is selected from 1-bromooctane, 1-bromododecane and 1-bromohexadecane.

In one embodiment the lipophilicity modifier is (C₁-C₂₀)-carboxylic acid, preferably (C₁₂-C₁₆)-carboxylic acid.

In one embodiment the lipophilicity modifier is (C₁-C₂₀)-acid chloride, preferably (C₁₂-C₁₆)-acid chloride.

In one embodiment the lipophilicity modifier is (C₁-C₂₀)-ester (e.g. triglyceride), preferably (C₁₂-C₁₆)-ester.

In one embodiment the lipophilicity modifier is added to the water-immiscible lipophilic solvent in an amount equivalent to about 0.5 to about 10 mol per glucose unit present in the spherical cellulose nanoparticles. The number of glucose units present may be calculated by dividing the mass of material by the molecular weight of monomeric glucose. The amount of lipophilicity modifier added depends on the degree of modification required and the number of lipophilic groups present in each lipophilicity modifier molecule.

In one embodiment the mol ratio of lipophilicity modifier to water-immiscible lipophilic solvent is about 1:20 to about 1:1, preferably about 1:10 to about 1:2, more preferably about 1:4 to about 1:5.

Where the lipophilicity modifier also constitutes the water-immiscible lipophilic solvent, such as a triacylglyceride, the lipophilic groups are present in excess, relative to the spherical cellulose nanoparticles. Similarly, where the water-immiscible lipophilic solvent is a plant oil, the triacylglyceride lipophilicity modifier will also be in excess.

In many cases, the lipophilicity modifier reacts readily with the cellulose hydroxyl groups. However, the reaction can be aided by reaction promotors.

In one embodiment the water-immiscible lipophilic solvent comprises a reaction promotor such as an acid (HCl, H₂SO₄, phosphoric acid), base (NaOH, KOH, carbonate, alkoxide), heterogeneous catalyst (alkaline earth metal oxide such as MgO, CaO or SrO), modified zeolite, anionic clay, ion-exchange resin, solid-base catalyst combination (Li/CaO, KF/Al₂O₃) or metal-based catalyst (platinum oxide, nickel oxide).

The emulsion may be formed by any means known in the art including sonication, high speed mechanical stirring, use of high-pressure, pumping air through the solution, etc.

In one embodiment, the emulsion comprises a wt ratio of about 1:50 to about 1:2 water-immiscible lipophilic solvent: alkali suspension of spherical cellulose nanoparticles, preferably about 1:20 to about 1:5, more preferably about 1:15 to about 1:8.

In one embodiment the spherical cellulose nanoparticles, water and a water-immiscible lipophilic solvent are sonicated to form the emulsion.

Following emulsification, the spherical cellulose nanoparticles are localised at the interface of the continuous (water) and dispersed (water-immiscible lipophilic solvent) phases of the emulsion. As would be recognised by a person skilled in the art, localisation at the interface means that the nanoparticles are predominantly found at the interface, with relatively few nanoparticles present in either the continuous or dispersed phases.

Localisation at the water-oil interface can be observed by addition of a fluorescent dye such as calcofluor-white, a dye that binds specifically to cellulose. Irradiation at the absorption maximum will induce the emission of fluorescence, which is observed at the water-oil interface. Following emulsification, fluorescent emission is observed only at the water-oil interface, indicating that the cellulose particles are located predominantly (or exclusively) at the water-oil interface.

In step (c) the portion of each spherical cellulose nanoparticle exposed to the lipophilicity modifier at the interface of the continuous and dispersed phases reacts with the lipophilicity modifier to produce a Janus-type spherical cellulose nanoparticle. In other words, the hydroxyl groups of the spherical cellulose nanoparticles that are in contact with the water-immiscible lipophilic solvent react with the lipophilicity modifier present in the solvent, so as to selectively modify one face of the nanoparticles.

In one embodiment, the emulsion is heated to start the reaction. In one embodiment, the emulsion is heated to a temperature of about 30 to about 70° C.

A person skilled in the art would understand that the longer the reaction time, the larger the portion of each spherical cellulose nanoparticle that is modified to be more lipophilic. Longer reaction times increase the lipophilicity of the modified face relative to the unmodified face, thereby decreasing the HLB of the particle.

In one embodiment, the emulsion is heated until the functionalised portion comprises about 30% to about 70% of the surface area of the nanoparticles on average, preferably about 40% to about 60%, more preferably about 45% to about 55% and most preferably about 50% of the surface area of the nanoparticles on average. The functionalised area of the spherical nanoparticles can be assessed by measuring the surface tension of water containing such particles.

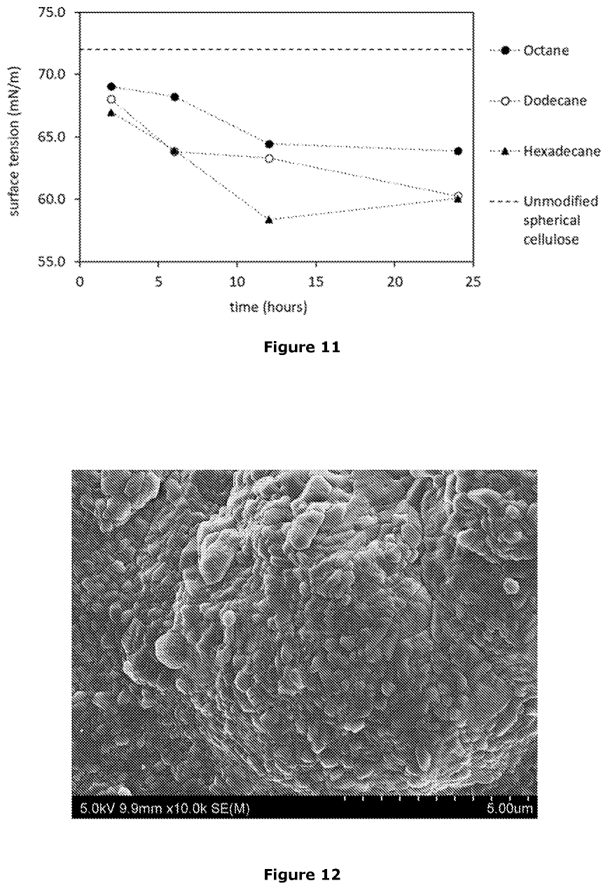

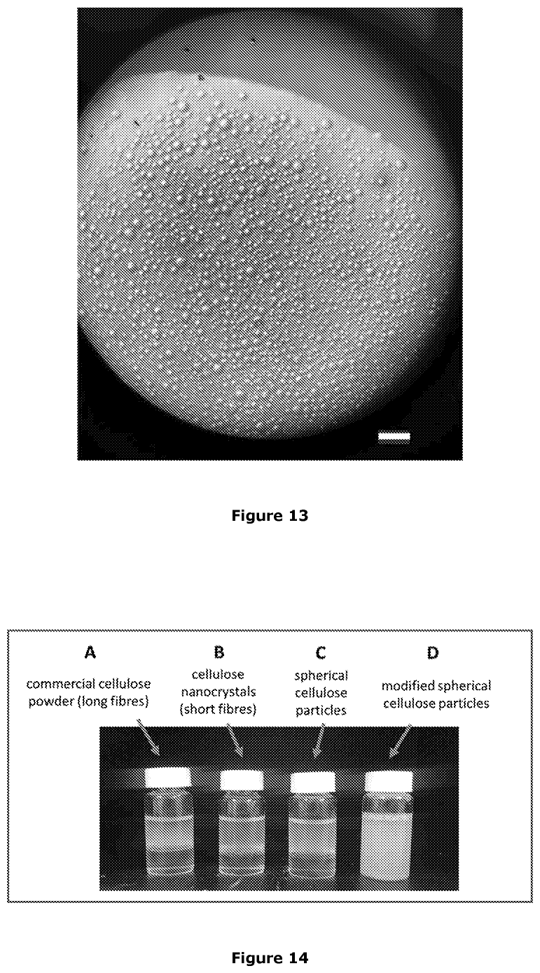

Spherical cellulose particles that do not possess two faces with different properties do not change the surface tension of water containing such particles. The observation of a decrease in the surface tension of water containing Janus-type spherical cellulose particles of the invention (FIGS. 8-11) confirms the amphiphilicity of these particles, with one lipophilic face and one hydrophilic face.

Cellulose spherical particles that do not have two distinct faces will not have this property. For example, particles that are uniformly modified with a lipophilic modifier across the whole surface of the spherical particle, without creating two faces, will not significantly decrease the surface tension of water.

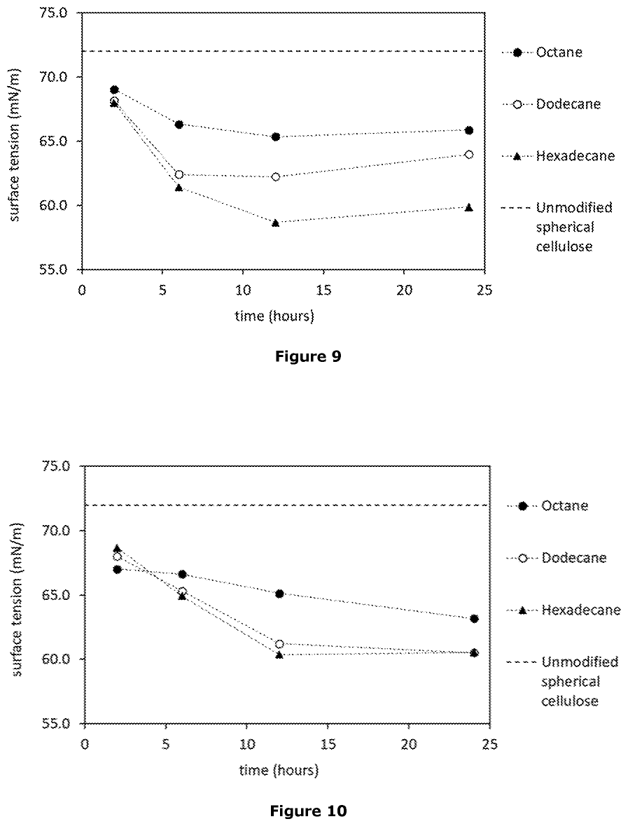

Unmodified spherical cellulose nanoparticles, which have a uniform hydrophilic surface, also do not reduce the surface tension of water when the nanoparticles are added to it. The surface tension of water remains at 72 mN/m in the presence of unmodified spherical cellulose nanoparticles but can decrease to 58 mN/m in the presence of Janus-type spherical cellulose particles modified with 1-bromohexadecane (FIG. 9).

In one embodiment the emulsion is heated at about 50° C. for about 2, 3, 4, 5, 6, 7, 8, 9, 10, 12, 15, 18, 20, 25 or 30 to about 36 hours. In one embodiment the emulsion is heated at about 50° C. for about 2 to about 12 hours. In one embodiment the emulsion is heated at about 50° C. for about 12 to about 36 hours.

In one embodiment the lipophilic modifier is alkyl bromide or triacylglyceride and the emulsion is heated at 50° C. for about 12 hours.

Following the reaction, the resulting Janus-type spherical cellulose nanoparticles are separated from the emulsion. Separation can be achieved using any standard techniques including but not limited to centrifugation, ultrafiltration and electrostatic precipitation.

In one embodiment the Janus-type spherical cellulose nanoparticles are separated from the emulsion by centrifugation.

The Janus-type spherical cellulose nanoparticles are then optionally washed to remove salt. In one embodiment, the Janus-type spherical cellulose nanoparticles are washed in water followed by ethanol.

The washed Janus-type spherical cellulose nanoparticles may also optionally be resuspended in water and treated with acid to reduce the pH of the suspension, before being separated again.

In one embodiment the Janus-type spherical cellulose nanoparticles are dried to provide a powder. Drying can be achieved by any known technique including but not limited to room temperature evaporation, drying under reduced pressure or freeze drying. In one aspect the invention provides Janus-type spherical cellulose nanoparticles.

In another aspect, the invention provides Janus-type spherical cellulose nanoparticles. In one embodiment, the Janus-type spherical cellulose nanoparticles are prepared in accordance with the process of the invention.

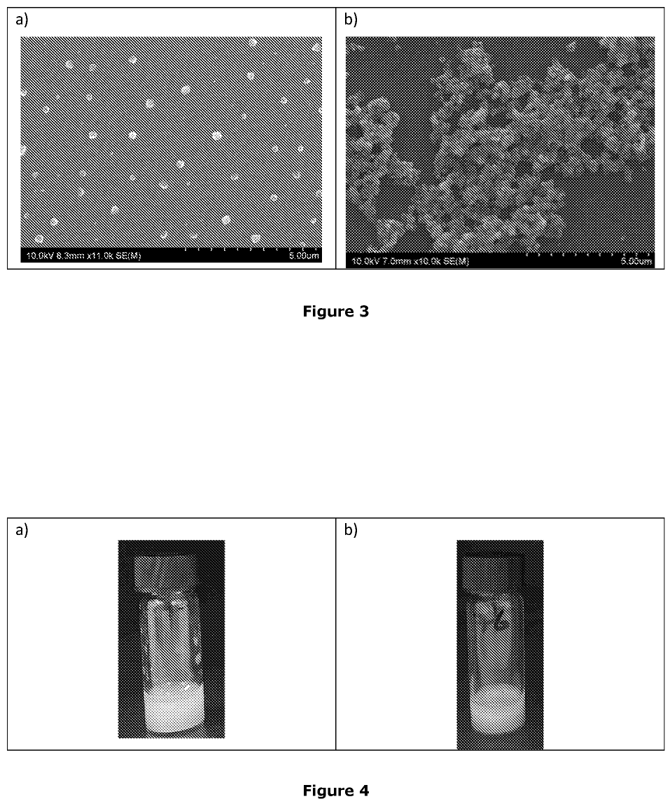

Example 2 describes the preparation of Janus-type spherical cellulose nanoparticles by reacting the lipophilic modifier 1-bromohexadecane in a toluene/water emulsion. FIG. 3 shows micrographs of the Janus-type spherical cellulose nanoparticles formed by Example 2.

In the Janus-type spherical cellulose nanoparticles of the invention, the surface of one face of each sphere is functionalised so as to be more lipophilic than the remaining surface of the sphere.

In one embodiment the surface of the Janus-type spherical cellulose nanoparticles is partially functionalised with (C₁-C₂₀) ether groups. In one embodiment the surface of the Janus-type spherical cellulose nanoparticles is partially functionalised with (C₁-C₂₀) ester groups.

In one embodiment the functionalised portion comprises about 30% to about 70% of the surface area of the spherical cellulose nanoparticles on average, preferably about 40% to about 60%, more preferably about 45% to about 55% and most preferably about 50% of the surface area of the spherical cellulose nanoparticles on average.

In one embodiment, the Janus-type spherical cellulose nanoparticles have a volume average particle diameter of about 10 nm to about 1000 nm, preferably about 20 nm to about 600 nm, more preferably about 20 to about 200 nm.

The Janus-type spherical cellulose nanoparticles of the invention are surfactants that can be used in many applications, including but not limited to: emulsifiers for foods and beverages, coatings, plastics, cosmetics and pharmaceuticals; foamers and defoamers for manufacturing, mining and mineral processing; cleaning agents for household, personal and industrial uses; and wetting agents for agricultural and industrial uses. In another embodiment the invention provides a surfactant composition comprising Janus-type spherical cellulose nanoparticles. In one embodiment the surfactant composition is a Pickering emulsion.

In one embodiment the invention provides a Pickering emulsion comprising Janus-type spherical cellulose nanoparticles.

To prepare an oil-in-water Pickering emulsion, Janus-type spherical cellulose nanoparticles are dispersed in water by mechanical stirring in a dispersing medium until a homogenous cellulose nanoparticle/water dispersion is visible. A volume of oil (up to 50% vol) is then added to the Janus-type spherical cellulose water dispersion and vigorously shaken or stirred in a dispersing medium to get oil-in-water emulsions.

In one embodiment the Pickering emulsion comprises about 0.01 to 10 wt % Janus-type spherical cellulose nanoparticles, preferably 0.05 to 5, more preferably 0.1 to 2 wt %.

In one embodiment, the Pickering emulsion is an oil-in-water emulsion comprising about 1 to about 50% oil by volume, preferably up to about 20% oil by volume. In one embodiment the Pickering emulsion includes no other emulsifiers other than the Janus-type spherical cellulose nanoparticles.

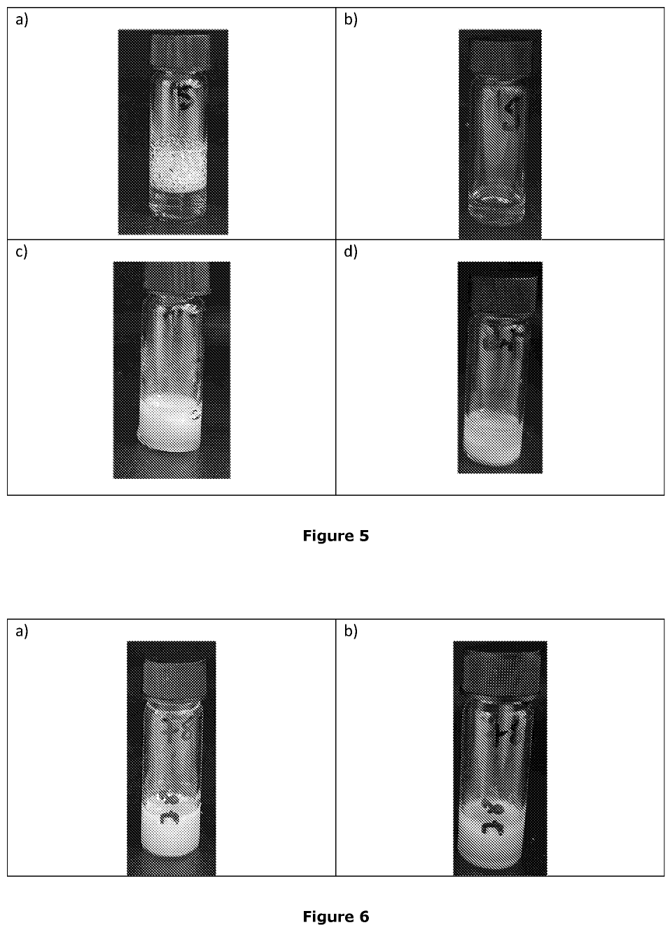

Example 3 describes the preparation of an oil-in-water Pickering emulsion comprising Janus-type spherical cellulose nanoparticles in 1:1 toluene/water. The Janus-type spherical cellulose nanoparticles of the invention demonstrate better emulsifying properties than comparable surfactants sodium dodecylbenzene sulfonate and polyoxyethylene (10) oleyl ether (see FIGS. 5 and 6).

Similar oil-in-water Pickering emulsions prepared using several water-immiscible liquids were found to be stable over 6 months, with no additives required to improve the emulsification. Accordingly, the described Janus-type spherical cellulose nanoparticles of the invention are excellent oil-in-water emulsifiers.

The HLB of the Janus-type spherical cellulose nanoparticles of the invention may be controlled by modification of the reaction conditions.

As described in Example 5, adding longer carbon chains to the cellulose nanoparticle surface increases the lipophilicity of the surface to a greater extent than adding shorter carbon chains (see FIGS. 8-11).

As also described in Examples 5 and 6, longer reaction times promote substitution of a greater percentage of the hydroxyl groups with the lipophilic chains, increasing the affinity of the spherical cellulose nanoparticles towards lipophilic fluids. On the other hand, lower reaction times lead to less than 50% of the surface area of the surface of the nanoparticles being modified. These spherical cellulose nanoparticles preserve more of their hydrophilic nature, allowing them to interact better with hydrophilic fluids (see FIGS. 8-11).

Longer reaction times and modification with longer carbon chains are conditions that decrease the HLB, favouring the production of spherical cellulose nanoparticles with the ability to stabilise oil-in-water emulsions with oil concentrations higher than 20% by volume. Lower reaction times and shorter carbon chain substitutes preserve most of the hydrophilic nature of the particles favouring the production of cellulose nanoparticles with the ability to stabilise oil-in-water emulsions with oil concentrations lower than 20% by volume.

Janus-type spherical cellulose nanoparticles of the invention with low HLB values can be used to stabilise water-in-oil emulsions.

In one embodiment, the Pickering emulsion is a water-in-oil emulsion with 1-50% water by volume.

The Janus-type spherical cellulose nanoparticles of the invention also have the advantage that they stabilise emulsions without generating foams. This is a highly desirable property because foaming is a problem in many surfactant applications. Foaming can artificially raise batch volumes and cause product loss, damage to equipment such as pumps, factory downtime and environmental pollution. For example, in the formulation of cosmetics, surfactants are added to act as emulsifiers so that the oily components can mix with water. Foam produced during mixing can clog pipes and valves as well as reducing the capacity of containers and complicating the transfer material from one container to another. Foam can also remain in the finished product causing clouding and voids which compromise the integrity of the product.

In another example, emulsifiers, dispersants and wetting agents are commonly added to paints and coatings formulations to allow all the components in paint to mix homogeneously. Added surfactants can produce foam during the manufacturing, packaging or application of the paint systems. Foaming during manufacturing and packaging clogs equipment and complicates container transfer. Foaming during application leaves surface defects, gives a poor visual appearance and reduces the protective function of the paint or coating.

### 6. EXAMPLES

### Example 1: General Process for Manufacture of Highly Spherical Cellulose Particles

Microcellulose powder containing particles that are 20 μm in diameter on average were first dispersed in a 5 M NaOH solution by mechanical stirring (10 mL of NaOH per 1 g of cellulose). After the particles were dispersed, the mixture was heated at 70° C. and stirred for 5 h. The mixture was cooled to room temperature and the cellulose isolated by filtration through filter paper. The cellulose was washed with deionised water and dried at room temperature and under reduced pressure.

The dried cellulose was suspended in dimethyl sulfoxide (10 ml of dimethyl sulfoxide per 1 g of cellulose) and sonicated for 2 min. The suspension was heated to 60° C. and left undisturbed for 4 h. The dimethyl sulfoxide was removed by filtration through filter paper. After washing with deionised water, the cellulose was dried under reduced pressure.

Acid hydrolysis was used to convert the microcellulose (˜20 μm) into nanocellulose (<1 μm). To achieve this, the dried cellulose was suspended in a 1:2 36 N sulfuric acid/water solution with magnetic stirring. Acid hydrolysis of the cellulose was carried out at 70° C. with stirring for 1 h. Aliquots of the suspension were taken every hour and analysed by dynamic light scattering to monitor the size of the particles. When the particles reached an average size of 1 μm, the reaction was stopped. Further acid hydrolysis was carried out using the same cellulose suspension, at 60° C., ultrasonic treatment, and mechanical stirring for 4 h. Aliquots were taken to check the size of the cellulose particles.

When the desired size is reached the hydrolysis is halted by cooling the suspension to room temperature. The particles were separated by centrifugation at 12000 rpm for 10 min. The solid was collected and washed with deionised water. A 5 M NaOH solution was added to the suspension until the pH was around 7. Three further washes with deionised water were performed to remove salts produced during the neutralisation. Water was removed by freeze-drying. At the end of this stage, spherical cellulose particles were produced with a volume average particle diameter ranging from 20 to 1000 nm (depending on when the hydrolysis is halted).

After 2 hours of acid hydrolysis, the spherical particles had a volume average particle diameter of about 500-1000 nm. After 4 hours of acid hydrolysis, the spherical particles had a volume average particle diameter of about 50-200 nm.

Spherical cellulose nanoparticles prepared in Example 1 are shown in FIG. 2.

### Example 2: Preparation of Janus-Type Spherical Nanoparticles of the Invention

Spherical cellulose nanoparticles prepared in accordance with Example 1 (having an average size from 50 to 200 nm) were modified using an etherification reaction with 1-bromohexadecane. To a suspension of 1 wt % spherical cellulose nanoparticles was added a sodium hydroxide solution (5 M) under magnetic stirring. After 30 minutes, sodium chloride (1 M) was added, and the mixture was homogenised and dispersed by ultrasonication. 1-Bromohexadecane (3 equivalents per mol of glucose unit) was mixed with toluene (>99% vol) in a proportion of 1:4. To the stable alkali cellulose suspension, the bromoalkene-toluene mixture, in a ratio of 1:9 in volume of cellulose suspension to the mixture, was added with ultrasonication. After 10 minutes of ultrasonication, a 1-bromohexadecane-toluene in water emulsion was formed. The emulsion was then heated to 50° C. under low-speed magnetic stirring for 12 h. The reaction was quenched with cold water. The resulting Janus-type spherical cellulose nanoparticles were separated from the emulsion droplets by means of high-speed centrifugation (15000 rpm) for 30 min. The cellulose nanoparticles were washed with water three times and ethanol three times. The particles were redispersed in water using ultrasonic treatment and the pH of the suspension was reduced to pH 7 by adding 1 M hydrochloric acid. The suspension was washed three times with water and the particles recovered by centrifugation. The Janus-type spherical cellulose nanoparticles were vacuum dried overnight.

Janus-type spherical cellulose nanoparticles prepared in Example 2 are shown in FIG. 3.

### Example 3: Pickering Emulsion Comprising Janus-Type Spherical Nanoparticles of the Invention

The Janus-type spherical cellulose nanoparticles prepared in Example 2 were redispersed in water by mechanical stirring in a sonication bath. Oil-in-water emulsions were prepared using 50% vol of water, 50% vol of toluene and 0.1 wt % of the modified cellulose particles. The mixture was stirred until an emulsion was formed. The emulsions were treated with ultrasonication to obtain stable emulsions. Pictures of the emulsion were taken at day 0 and day 60, as seen in FIG. 4.

As seen in FIG. 4, the emulsion at day 0 is highly stable and homogenous. On day 60, the emulsion is still visible in the vial. To compare the ability to stabilise 1:1 toluene in water emulsions using the spherical cellulose nanoparticles of the invention, emulsions were prepared using the same conditions with sodium dodecylbenzene sulfonate and polyoxyethylene (10) oleyl ether. Pictures of these emulsions were taken at day 0 and day 60, as seen in FIG. 5.

As can be seen from FIGS. 4 and 5, the Janus-type spherical cellulose nanoparticles of the invention show better emulsifying properties than the surfactants sodium dodecylbenzene sulfonate and polyoxyethylene (10) oleyl ether. The toluene-in-water emulsion with sodium dodecylbenzene sulfonate (just after being formed) is not homogenous, the two phases (oil and water) are still present, and a considerable amount of foam is formed on top of the liquids. After 60 days, there is no evidence of an emulsion, and the two phases have been completely separated. In a second example, the toluene in water emulsion with polyoxyethylene (10) oleyl ether show emulsifying properties similar to the one with the Janus-type spherical cellulose nanoparticles of the invention at day 0. However, the stability after 60 days shows that the emulsion using polyoxyethylene (10) oleyl ether is not stable since there is evidence of creaming and the phase separation.

### Example 4: Further Pickering Emulsions Comprising Janus-Type Spherical Cellulose Nanoparticles of the Invention

Janus-type spherical nanoparticles of the invention were prepared in accordance with Example 2 but replacing 1-bromohexadecane with the shorter chain 1-bromododecane. The shorter chain modified Janus-type spherical cellulose nanoparticles were redispersed in water by mechanical stirring. Oil-in-water emulsions were prepared to have a concentration of 90% vol Janus-type spherical cellulose nanoparticle suspension (comprising 0.1% wt dried Janus-type spherical cellulose nanoparticles) and 10% vol toluene. The mixture was stirred until an emulsion was visibly formed. The emulsions were treated with ultrasonication to form stable emulsions. Pictures of the emulsions were taken on day 0 and day 30, as seen in FIG. 6.

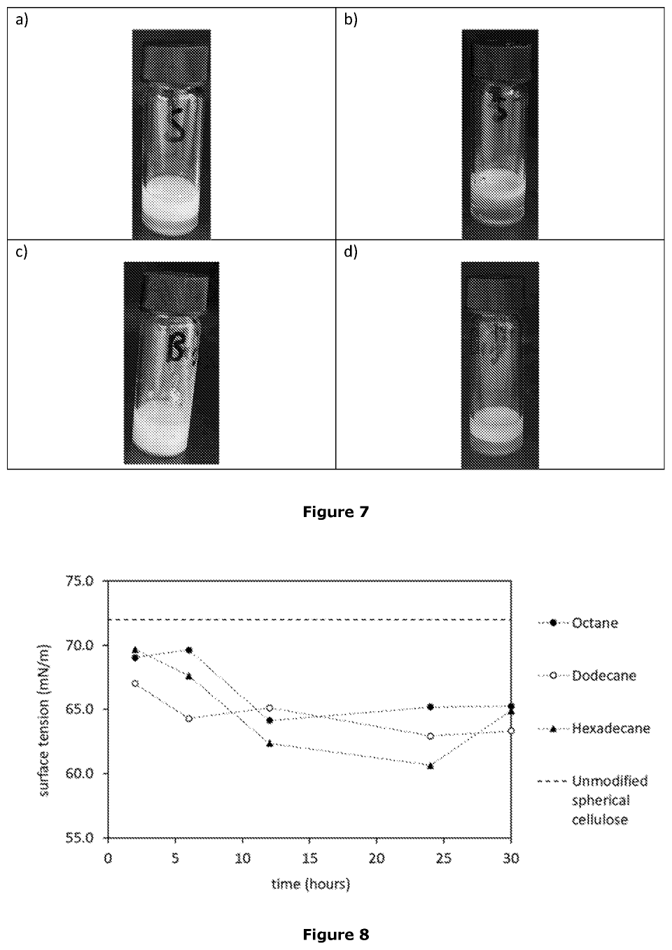

As seen in FIG. 6, the stability and homogeneity of the emulsion are high at day 0. After 30 days, the emulsion is still visible in the vial. To compare the performance to stabilise 1:9 toluene-in-water emulsions with the Janus-type spherical cellulose nanoparticles of the invention, emulsions were prepared under the same conditions with sodium dodecylbenzene sulfonate and polyoxyethylene (10) oleyl ether. Pictures of the emulsions were taken on day 0 and day 30, as seen in FIG. 7.

As can be seen from FIG. 7, the emulsion formed with sodium dodecylbenzene sulfonate is not as stable since some creaming is observed straight after the emulsification. By contrast, the emulsion obtained with polyoxyethylene (10) oleyl ether is homogenous and stable. It can be said then that the emulsions prepared with polyoxyethylene (10) oleyl ether and the Janus-type spherical cellulose nanoparticles in this example are equally stable and homogenous after the emulsification. However, the emulsions stabilised by both the polyoxyethylene (10) oleyl ether and sodium dodecylbenzene sulfonate present some creaming on top, a natural phenomenon when the emulsions are not stable anymore and the phase separation is likely to occur. On the other hand, the oil emulsion droplets obtained with the Janus-type spherical cellulose nanoparticles are still dispersed throughout the water phase and less creaming is observed. This suggests that the Janus-type spherical nanoparticles modified with 1-bromododecane have better performance than polyoxyethylene (10) and sodium dodecylbenzene sulfonate to stabilise toluene-in-water emulsions with an oil concentration of 10% v.

### Example 5: Amphiphilicity of Janus-Type Spherical Nanoparticles of the Invention

To explore how the amphiphilicity of the surface of the Janus-type spherical cellulose nanoparticles is controlled either by the reaction time or the length of the introduced hydrophobic chain, nanoparticles were prepared in accordance with the process of Example 2. Three sets of Janus-type spherical cellulose nanoparticles were prepared, by etherification modification with 1-bromohexadecane, 1-bromododecane, and 1-bromooctane, respectively. The reduction in the surface tension of water is one of the parameters used to estimate the amphiphilicity of a molecule. FIGS. 8 to 11 show an overview of the surface tension reduction over time measured with the pendant drop method and using a suspension of 1 wt % Janus-type spherical cellulose nanoparticles in water. They were produced with the following variations:
Chloroform in water emulsion without stirring
Chloroform in water emulsion with magnetic stirring
Toluene in water emulsion without stirring
Toluene in water emulsion with magnetic stirring
   and compared with unmodified spherical cellulose nanoparticles. The results in FIGS. 8 to 11 show that the surface tension is reduced with increasing reaction times until it reaches a plateau. After this point, the surface tension tends to be stable or is increased (as seen in FIG. 8). This phenomenon can be explained by the fact that the modification of the spherical cellulose nanoparticle has reached a point where the particles are more lipophilic, losing the amphiphilicity to some extent so that the surface tension increases. The highest surface tension reduction is 58 mN/m observed at a reaction time of 12 h when using the toluene in water emulsion with magnetic stirring. This value is not as low as the values obtained with some other surfactants that can be lower than 40 mN/m.

In addition, the water-immiscible solvent used for the emulsification prior to the surface modification step has been determined to slightly increase or reduce the reaction rate, which has been identified by the different values of surface tension obtained while using chloroform or toluene as the water-immiscible lipophilic solvent.

### Example 6: Effect of Reaction Time on Pickering Emulsions Comprising Janus-Type Spherical Nanoparticles of the Invention

Janus-type spherical nanoparticles of the invention were prepared in accordance with the process set out in Example 2, but with varying reaction times (2, 6, 12 and 24 hours). The resulting particles were used to prepare oil-in-water Pickering emulsions with a concentration of 90% vol Janus-type spherical cellulose nanoparticle suspension (comprising 0.5% wt dried Janus-type spherical cellulose nanoparticles) and 10% vol toluene (1:9 v). The process used is described in Example 3.

Analogous 1:9 v emulsions were prepared using 0.5 wt % control surfactant (Brij O10-polyoxyethylene (10) oleyl ether—9004-98-2) and unmodified spherical cellulose nanoparticles (SCN).

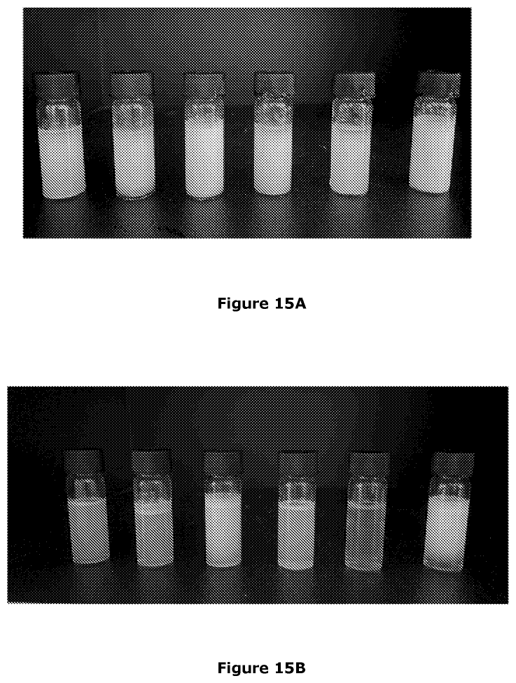

The Pickering emulsions were photographed 5 minutes and 7 days after formation. The results are shown in FIG. 15.

A second set of Pickering emulsions was prepared comprising 50% vol of Janus-type spherical cellulose nanoparticle suspension (comprising 0.5% wt dried Janus-type spherical cellulose nanoparticles) and 50% vol toluene (1:1 v). Analogous 1:1 v emulsions were prepared using 0.5 wt % control surfactant (Brij O10-polyoxyethylene (10) oleyl ether—9004-98-2) and unmodified spherical cellulose nanoparticles (SCN).

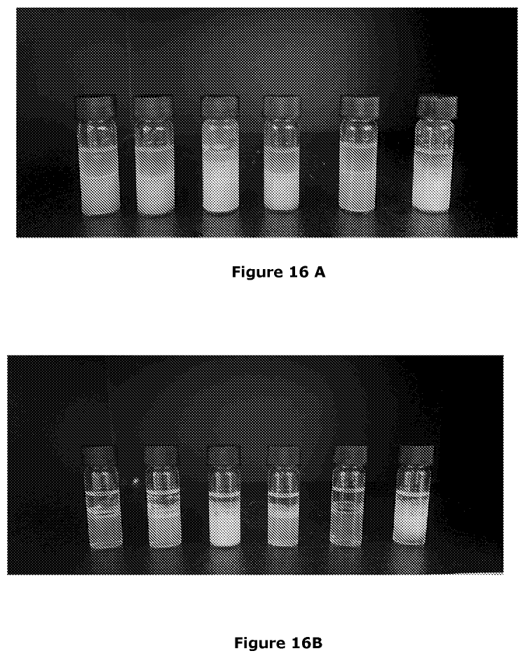

The Pickering emulsions were photographed 5 minutes and 7 days after formation. The results are shown in FIG. 16.

The stability of selected emulsions (1:9 v, 12 hrs vs Brij O10 and 1:1 v 12 hrs vs Brij O10) was determined by measuring the creaming index. This involves determining the ratio between the cream layer height and the total emulsion layer height. The creaming index is a physical assessment of emulsion stability where values closer to zero indicate greater stability.

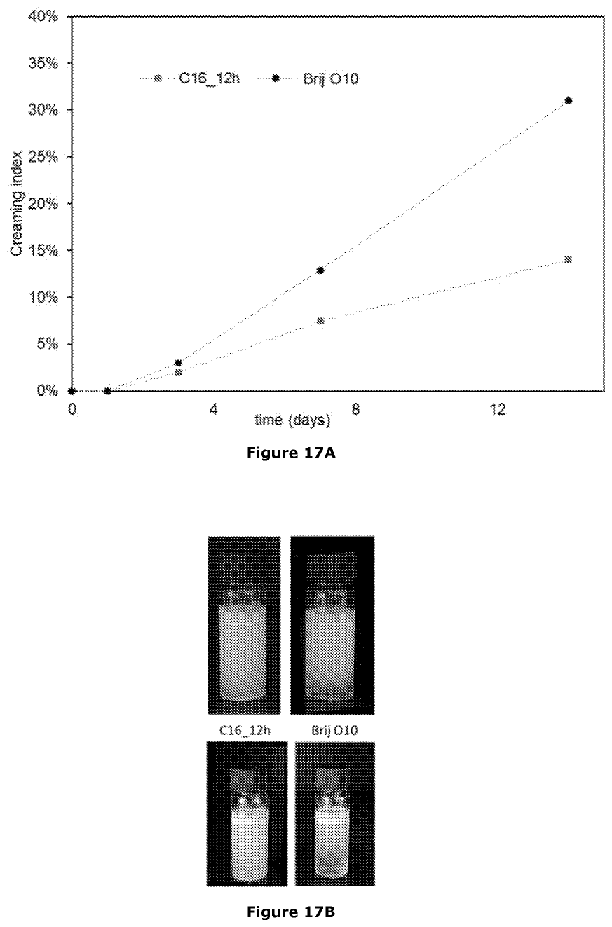

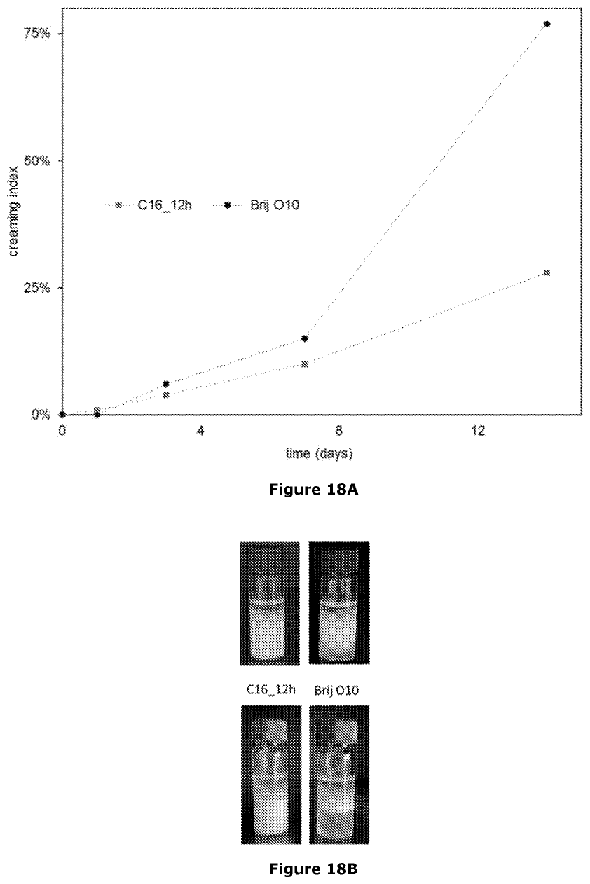

The results are shown in FIGS. 17 and 18. In both cases, the Pickering emulsions comprising Janus-type spherical cellulose nanoparticles had a lower creaming index than the control surfactant (Brij O10).

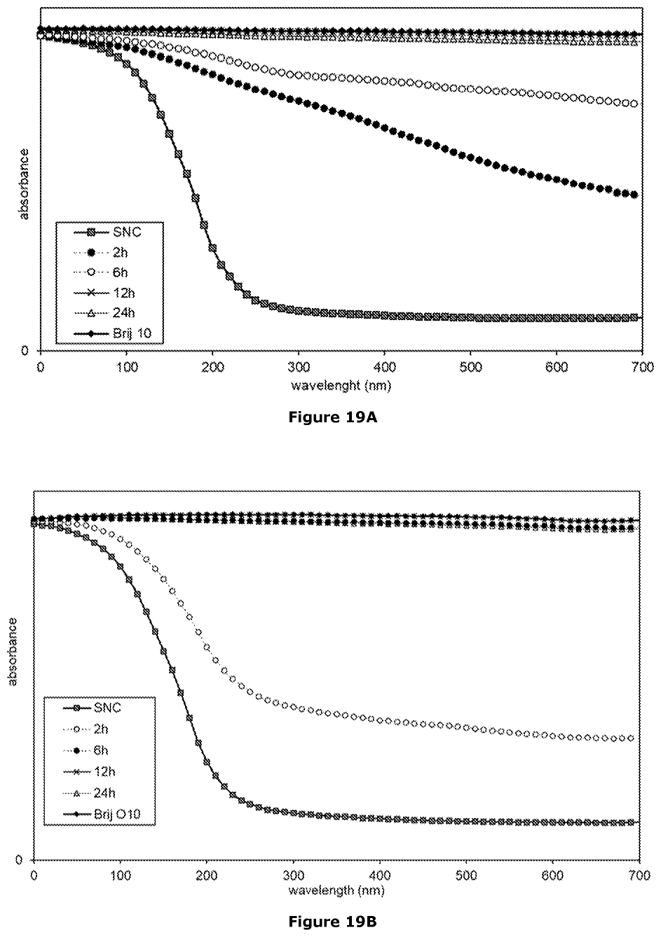

The stability of all of the Pickering emulsions was also assessed by measuring their turbidity, measured by UV absorbance (at 550 nm). The results are shown in FIG. 19 where it can be seen that the Pickering emulsions comprising Janus-type spherical cellulose nanoparticles retain turbidity for much longer than Pickering emulsions prepared using unmodified spherical cellulose nanoparticles (SCN). The Pickering emulsions comprising Janus-type spherical cellulose nanoparticles reacted for 12 and 24 hours have comparable turbidity to the surfactant control Brij O10.

### Example 7: Foaming Properties of Janus-Type Spherical Cellulose Nanoparticles when Stabilising Pickering Emulsions

The ability of Janus-type spherical cellulose nanoparticles (prepared as per Example 2) to produce foam was measured by introducing a surfactant-containing solution in a reservoir from a specific height into a column containing the same solution, in accordance with the Ross-Miles method ASTM D1173-07 (Reapproved 2015): Standard Test Method for Foaming Properties of Surface-Active Agents, and compared to several commercially available surfactants, as shown in Table 1. (J. Ross, 1941)

TABLE 1
Foaming height measured by the
Ross-Miles method (ASTM D 1173)

| Surfactant | Height (cm) |
|---|---|
| Spherical nanocellulose (SNC) | 0 |
| C16 Janus-type SCN | 0.1 |
| C12-C15 pareth-7 | 10.8 |
| Lauryl glucoside | 8.7 |
| Sodium lauryl sulfate | 8 |

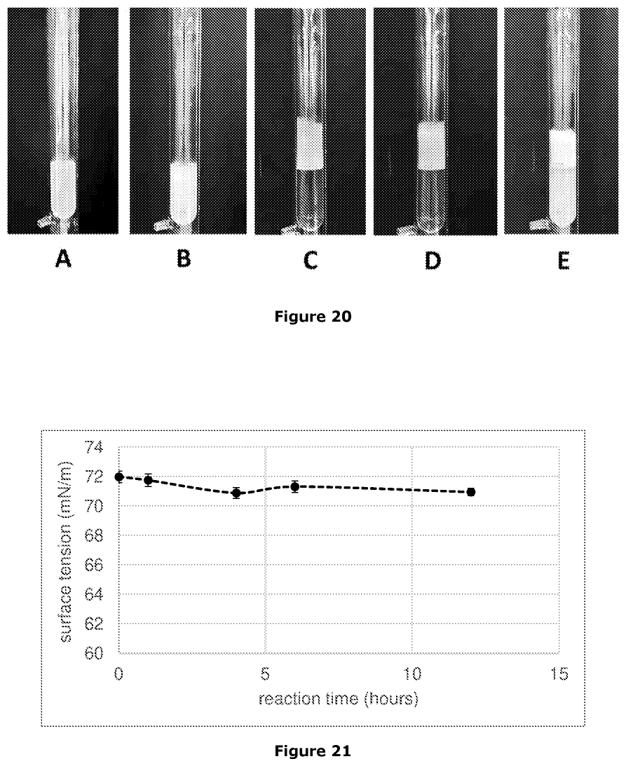

The Janus-type cellulose particles were shown to not stabilise form at all, showing a foam height of 0 cm, in contrast to surfactants such as C12-C15 pareth-7, lauryl glucoside and sodium lauryl sulfate, which demonstrated foam heights between 8 and 11 cm (see FIG. 20I).

### Example 8: Detergent Action of Janus-Type Spherical Cellulose Nanoparticles of the Invention

A pre-soiled material swatch (sourced from Lubrizol Life Science) was mixed with surfactant (0.083%), placed into a 8-pot James Heal Gyrowash and mixed with stainless steel ball bearings (to simulate mechanical mixing) for 40 min at 30° C. The reflectance of the stain before and after the wash was measured using a Datacolor 500 spectrophotometer.

As shown in Table 2, the Janus-type spherical cellulose nanoparticles of the invention showed were clearly able to remove make-up stains, comparable to commercially available detergents C12-C15 pareth 7, lauryl glucoside and sodium coco sulfate.

TABLE 2
Percentage removal of make-up from a pre-stained cloth

| Surfactant | % removal |
|---|---|
| C12-C15 pareth-7 | 55 |
| Lauryl Glucoside | 41 |
| Sodium Coco Sulphate | 50 |
| Janus-type SNP | 42 |

### Example 9: Comparison of Surface Activity

To demonstrate the distinct properties of the Janus-type spherical cellulose particles of the invention, their surface activity was directly compared to homogenously modified particles. Firstly, ummodified spherical cellulose nanoparticles were modified homogeneously (without creating two faces) by initial treatment with a solution of NaOH 7% wt for 1 hour at 60° C. The sample was then separated, washed, and dried. These activated spherical cellulose particles were then dispersed in DMF and sonicated. The lipophilic modifier bromohexadecane was then added dropwise under stirring at 60° C. for set times (1, 4, 6 and 12 hours), then washed and separated. The surface activity of these homogeneously modified cellulose particles was determined by the pendant drop method to measure its ability to reduce the surface tension of water. The homogeneously modified particles were not able to significantly decrease the surface tension of water (surface tension was measured to be 70.9-72 mN/m) (FIG. 21). In contrast, the Janus-type spherical cellulose particles of the invention show much higher surface activity, which is consistent with theoretical predictions for the behaviour of Janus particles at interfaces. (Fletcher, 2001) (Miguel Angel Fernandez-Rodriguez, 2016).

### 7. REFERENCES

Casagrande, C., Fabre, P., Raphaël, E., & Veyssié, M. (1989). “Janus Beads”: realization and behaviour at water/oil interfaces. EPL Europhys Lett., 9 (3), 251.
Chen, X.-Q., Deng, X.-Y., Shen, W.-H., & Jia, M.-Y. (2018). Preparation and characterization of the spherical nanosized cellulose by the enzymatic hydrolysis of pulp fibers. Carbohydrate Polymers, 181, 879.
Dong, H., Ding, Q., Jiang, Y., Li, X., & Han, W. (2021). Pickering emulsions stabilized by spherical cellulose nanocrystals. Carbohydrate Polymers, 265, 118101. doi: https://doi.org/10.1016/j.carbpol.2021.118101
Fletcher, B. P. (2001). Particles Adsorbed at the Oil-Water Interface: A Theoretical Comparison between Spheres of Uniform Wettability and “Janus” Particles. Langmuir, 17, 4708-4710.
J. Ross, G. D. (1941). An Apparatus for Comparison of Foaming Properties of Soaps and Detergents, Oil & Soap. 18, 99-102.
Li, D.-d., Jiang, J.-z., & Cai, C. (2020). Palladium nanoparticles anchored on amphiphilic Janus-type cellulose nanocrystals for Pickering interfacial catalysis. Chem. Commun., 56, 9396-9399.
Li, T., Liu, B., Wang, W., Sagis, L. M., Yuan, Q., Lei, X., . . . Li, Y. (2020). Corncob cellulose nanosphere as an eco-friendly detergent. Nature Sustainability, 3, 448.
Meyabadi, T. F., Dadashian, F., Sadeghi, G. M., & Asl, H. E. (2014). Spherical cellulose nanoparticles preparation from waste cotton using a green method. Powder Technology, 261, 232-240.
Miguel Angel Fernandez-Rodriguez, M. A.-V.-V.-A. (2016). Surface activity of Janus particles adsorbed at fluid-fluid interfaces: Theoretical and experimental aspects. Advances in Colloid and Interface Science, 233, 240-254.
Zhang, J., Elder, T. J., Pu, Y., & Ragauskas, A. J. (2007). Facile synthesis of spherical cellulose nanoparticles. Carbohydrate Polymers, 69, 607-611.

1. A process for preparing Janus-type spherical cellulose nanoparticles comprising:
(a) preparing an alkali suspension of spherical cellulose nanoparticles in water;
(b) forming an emulsion comprising the spherical cellulose nanoparticles, water and a water-immiscible lipophilic solvent, wherein:
(i) the water constitutes the continuous phase,
(ii) the lipophilic solvent constitutes the dispersed phase and comprises a lipophilicity modifier, and
(iii) the spherical cellulose nanoparticles are localised at the interface of the continuous and dispersed phases;
(c) reacting the lipophilicity modifier with the portion of the spherical cellulose nanoparticles exposed to the lipophilicity modifier at the interface of the continuous and dispersed phases to produce Janus-type spherical cellulose nanoparticles; and
(d) separating the Janus-type spherical cellulose nanoparticles from the emulsion.

2. The process according to claim 1, wherein the alkali suspension comprises a wt ratio of about 1:1 to about 2:1 base: spherical cellulose nanoparticles, wherein the base is selected from the group consisting of NaOH, KOH and LiOH.

3. The process according to claim 1 wherein the alkali suspension of spherical cellulose nanoparticles is mixed with water and a water-immiscible lipophilic solvent to form an emulsion, in which the water constitutes the continuous phase and the lipophilic solvent constitutes the dispersed phase.

4. The process according to claim 1 wherein the water-immiscible lipophilic solvent is selected from the group consisting of toluene, chloroform, hexane, pentane, benzene, carbon tetrachloride, heptane dichloromethane and ethyl acetate.

5. The process according to claim 1 wherein the water-immiscible lipophilic solvent or consists essentially of a lipophilicity modifier.

6. The process according to claim 5 wherein the lipophilicity modifier consists essentially of a triacylglyceride.

7. The process according to claim 1 wherein the lipophilicity modifier is added to the water-immiscible lipophilic solvent prior to emulsification.

8. The process according to claim 1 wherein the lipophilicity modifier comprises an alkyl halide or pseudohalide.

9. The process according to claim 1 wherein the lipophilicity modifier comprises an acid chloride.

10. The process according to claim 1 wherein the lipophilicity modifier comprises (C1-C20)-carboxylic acid or (C1-C20)-ester.

11. The process according to claim 1 wherein the lipophilicity modifier is added to the water-immiscible lipophilic solvent in an amount equivalent to about 0.5 to about 10 mol per glucose unit present in the spherical cellulose nanoparticles.

12. The process according to claim 1 wherein the mol ratio of lipophilicity modifier to water-immiscible lipophilic solvent is about 1:20 to about 1:1.

13. The process according to claim 1 wherein the emulsion comprises a wt ratio of about 1:50 to about 1:2 water-immiscible lipophilic solvent: alkali suspension of spherical cellulose nanoparticles.

14. The process according to claim 1 wherein the emulsion is heated to about 30 to about 70° C.

15. The process according to claim 1 wherein the emulsion is heated until the functionalised portion comprises about 30% to about 70% of the surface area of the spherical nanoparticles on average.

16. Janus-type spherical cellulose nanoparticles with a volume average particle diameter of about 10 nm to about 1000 nm in which the surface of one face of each nanoparticle sphere is functionalised so as to be more lipophilic than the remaining surface of the sphere.

17. The Janus-type spherical cellulose nanoparticles of claim 16 which are partially functionalised with (C1-C20) ether groups or (C1-C20) ester groups.

18. The Janus-type spherical cellulose nanoparticles of claim 16 in which the functionalised portion comprises about 30% to about 70% of the surface area of the nanoparticles on average.

19. (canceled)

20. A surfactant composition that is a Pickering emulsion comprising about 0.01 to 1 wt % of the Janus-type spherical cellulose nanoparticles of claim 16.
